(19) United States
(12) Patent Application Publication
(10) Pub. No.: US 2015/0211575 A1
(43) Pub. Date: Jul. 30, 2015

(54) DRIVING DEVICE AND BEARING INCLUDING THE SAME

(71) Applicant: Samsung Electronics Co., Ltd., Suwon-Si (KR)

(72) Inventor: Oui-serg KIM, Seongnam-si (KR)

(21) Appl. No.: 14/499,976

(22) Filed: Sep. 29, 2014

(30) Foreign Application Priority Data
Jan. 28, 2014 (KR) 10-2014-0010722

(51) Int. Cl. F16C 32/04

(52) U.S. Cl. CPC F16C 32/0461

(57) ABSTRACT

A driving device configured to control vertical movement of an object adjacent thereto includes a core, and a plurality of coils connected in parallel and wound around the core to form lines of electromagnetic force in a same direction.

### CROSS REFERENCE TO RELATED APPLICATION

This application claims the benefit of Korean Patent Application No. 10-2014-0010722, filed on Jan. 28, 2014, in the Korean Intellectual Property Office, the disclosure of which is incorporated herein in its entirety by reference.

### BACKGROUND

1. Field

Example embodiments of the inventive concepts relate to a driving device, and more particularly, to a driving device including an improved electromagnet and a bearing using the electromagnet.

2. Description of the Related Art

Driving devices may generate force sufficient to support or drive an object. Electromagnetic driving devices generate electromagnetic force by using electromagnets. Electromagnetic driving devices may support or drive a heavier object if the sectional area of a core, the number of turns of a coil, or the current is increased. The method of increasing the number of turns of a coil of an electromagnetic driving device is effective in increasing the electromagnetic force of the electromagnet driving device. In example embodiments, however, the inductance of the electromagnetic driving device is also increased which results in lessening dynamic response characteristics of the electromagnetic driving device, and thus the electromagnetic driving device may have slower response characteristics. In addition, because the impedance of the coil is increased in proportion to the number of turns of the coil, electricity loss may also be increased. Furthermore, heat generated as a result of electricity loss may cause thermal deformation of materials of the electromagnetic driving device and thus may lower the operational reliability of the electromagnetic driving device.

### SUMMARY

Example embodiments of the inventive concepts provide a driving device having relatively quick response dynamic characteristics and configured to undergo minimized or reduced thermal deformation.

According to example embodiments of the inventive concepts, a driving device configured to control vertical movement of an object adjacent thereto includes a core, and a plurality of coils connected in parallel and wound around the core to form lines of electromagnetic force in a same direction.

The plurality of coils may be arranged in a direction perpendicular to a winding direction thereof to form at least one coil stack structure.

The driving device may further include at least one first cooling device disposed between the plurality of coils.

The at least one first cooling device may include a plate adjacent to a side surface of the plurality of coils, and a plurality of fins on the plate.

The at least one first cooling device may be around the core between the plurality of coils and may include a plurality of Peltier modules.

The at least one first cooling device may be a plurality of first cooling devices, and the plurality of first cooling devices may be arranged in a direction perpendicular to the winding direction of the plurality of coils and connected to both sides of the plurality of coils.

A length of each of the plurality of coils measured in a direction perpendicular to the winding direction of the plurality of coils may be greater than a gap between an adjacent two of the plurality of coils.

The core may be C-shaped and may include two protrusions, and the at least one coil stack structure may include first and second coil stack structures, the first coil stack structure around the first protrusion and the second coil stack structure around the second protrusion.

The core may include a plurality of protrusions, and the at least one coil stack structure may be around at least one of the plurality of protrusions.

The at least one coil stack structure may include a plurality of coil stack structures, and the driving device may further include a second cooling device between an adjacent two of the plurality of coil stack structures.

According to example embodiments of the inventive concepts, a bearing includes at least one electromagnet including a core, a plurality of coils connected in parallel and wound around the core in a direction perpendicular to a winding direction thereof, and at least one first cooling device between the plurality of coils, and a controller configured to detect a distance between the electromagnet and an object facing a magnetic pole of the electromagnet and configured to control a current supplied to the electromagnet according to the distance.

The bearing may further include a main body including the at least one electromagnet and the controller, the main body having a surface facing a surface of the object, wherein the at least one electromagnet may be connected to the main body such that a horizontal surface of the at least one electromagnet having the magnetic pole is exposed.

The main body may be a rail, and the object may be movable along the length of the rail.

The bearing may further include a ring-shaped part having an inner wall connected to the at least one electromagnet, wherein the at least one electromagnet may protrude toward a centerline of the ring-shaped part, and the object may be a rotary part having the same centerline as the ring-shaped part.

The at least one electromagnet may be a plurality of electromagnets, and the bearing may further include a second cooling device disposed between the plurality of electromagnets and connected to the inner wall of the ring-shaped part.

According to example embodiments of the inventive concepts, an electromagnet for a driving device includes a core, and at least one coil structure wound around the core, the at least one coil structure including a plurality of coils connected in parallel.

The plurality of coils may be arranged in a direction perpendicular to a winding direction thereof.

The electromagnet may further include at least one first cooling device around the core and between the plurality of coils. The at least one first cooling device may be in a direction perpendicular to the winding direction of the plurality of coils and connected to both sides of the plurality of coils.

The at least one coil stack structure may include a plurality of coil stack structures, and the electromagnet may further include a second cooling device between an adjacent two of the plurality of coil stack structures.

The core may be C-shaped and may include first and second protrusions, and the at least one coil stack structure may include first and second coil stack structures, the first coil stack structure around the first protrusion and the second coil stack structure around the second protrusion.

### BRIEF DESCRIPTION OF THE DRAWINGS

Example embodiments of the inventive concepts will be more clearly understood from the following detailed description taken in conjunction with the accompanying drawings in which:

FIGS. 1A to 2B are perspective views and cross-sectional views illustrating driving devices according to example embodiments of the inventive concepts;

FIGS. 3 and 4 are cross-sectional views illustrating cooling devices of the driving devices according to example embodiments of the inventive concepts;

FIGS. 5A to 6C are perspective views and cross-sectional views illustrating driving devices according to example embodiments of the inventive concepts;

FIGS. 7A-1 to 7A-2 are perspective views illustrating a linear motion bearing according to example embodiments of the inventive concepts, and FIG. 7B is a cross-sectional view illustrating a linear motion bearing according to example embodiments of the inventive concepts;

FIG. 8 is an enlarged perspective view illustrating an electromagnet and a controller of the linear motion bearing illustrated in FIGS. 7A-1 to 7B;

FIGS. 9A-1 to 9B are perspective views illustrating a linear motion bearing according to example embodiments of the inventive concepts, and FIG. 9B is a cross-sectional view illustrating a linear motion bearing according to example embodiments of the inventive concepts; and

FIGS. 10A to 11B are perspective views and cross-sectional views illustrating rotary motion bearings according to example embodiments of the inventive concepts.

### DETAILED DESCRIPTION

As used herein, the term “and/or” includes any and all combinations of one or more of the associated listed items. Expressions such as “at least one of,” when preceding a list of elements, modify the entire list of elements and do not modify the individual elements of the list.

Hereinafter, example embodiments of the inventive concepts will be described in detail with reference to the accompanying drawings. In the drawings, like reference numerals denote like elements, and descriptions thereof will not be repeated.

The inventive concepts may, however, be embodied in many different forms and should not be construed as being limited to the embodiments set forth herein; rather, these embodiments are provided to give a clear understanding of the inventive concepts to those of ordinary skill in the art. That is, the embodiments are provided so that this disclosure will be thorough and complete, and will fully convey the inventive concepts to those of ordinary skill in the art

It will be understood that, although the terms first, second, etc. may be used herein to describe various members, regions, layers, sections, and/or elements, these members, regions, layers, sections and/or elements should not be limited by these terms. These terms are not used to denote a particular order, a positional relationship, or ratings of members, regions, layers, sections, or elements, but are only used to distinguish one member, region, layer, section, or element from another member, region, layer, section, or element. Thus, a first member, region, layer, section, or element discussed below could be termed a second member, region, layer, section, or element without departing from the teachings of the inventive concepts. For example, a first element may be termed a second element, or a second element may be termed a first element without departing from the teachings of the inventive concepts.

Unless otherwise defined, all terms (including technical and scientific terms) used herein have the same meaning as commonly understood by those of ordinary skill in the art to which the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The order of processes explained in one embodiment may be changed in a modification of the embodiment or another embodiment. For example, two processes sequentially explained may be performed substantially at the same time or in the reverse of the explained order.

Shapes illustrated in the drawings may be varied according to various factors such as manufacturing methods and/or tolerances. That is, example embodiments of the inventive concepts are not limited to particular shapes illustrated in the drawings. Factors such as shape changes in manufacturing processes should be considered.

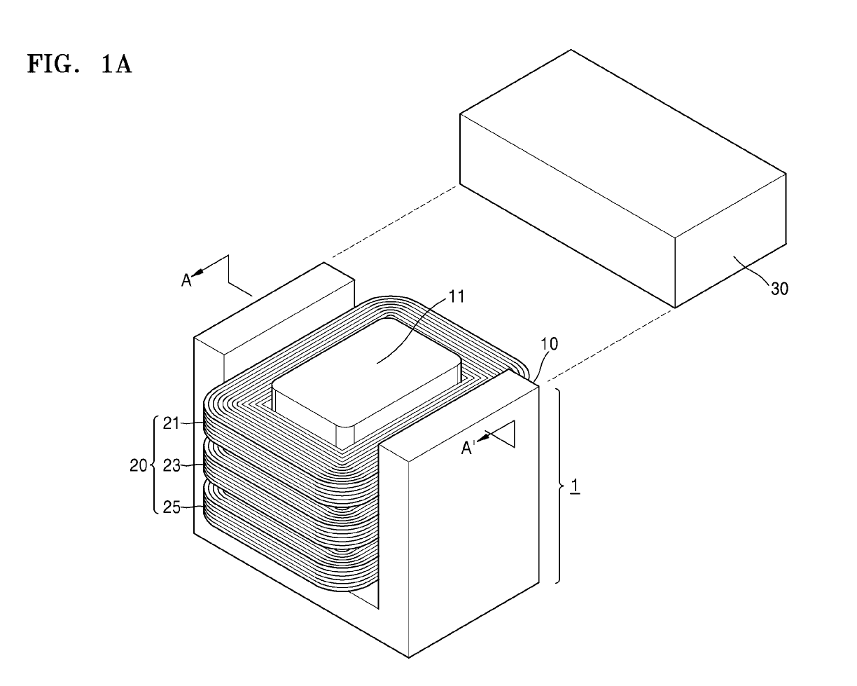

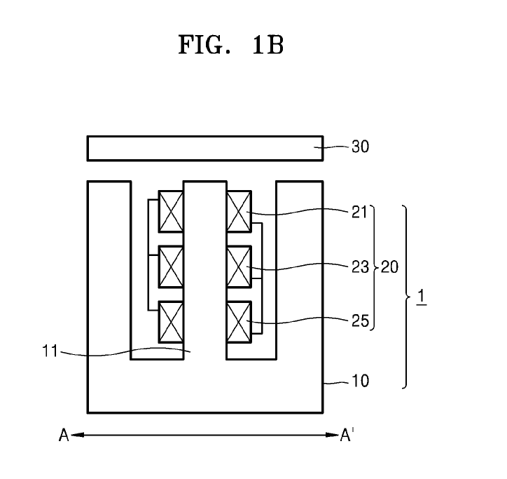

FIG. 1A is a perspective view illustrating a driving device 1 according to example embodiments of the inventive concepts.

Referring to FIG. 1A, a first coil 21, a second coil 23, and a third coil 25 are separately wound around a center protrusion 11 of an E-shaped core 10 so as to form a coil stack structure 20. The first, second and third coils 21, 23, and 25 may be wound in an overlapped manner. The first, second, and third coils 21, 23, and 25 are connected in parallel.

An object 30 to be supported by the driving device 1 is disposed to face a horizontal surface of the core 10. In FIG. 1A, the object 30 is placed at a position denoted by dashed lines extending therefrom for clarity. In an actual structure, however, the object 30 is disposed to face the horizontal surface of the core 10 of the driving device 1, and vertical movement of the object 30 is controlled by electromagnetic force of the driving device 1.

FIG. 1B is a cross-sectional view illustrating the driving device 1 according to example embodiments of the inventive concepts. Line “A-A” of FIG. 1B denotes that the cross-sectional view of the driving device 1 is taken along line A-A′ of FIG. 1A.

Referring to FIG. 1B, the core 10 may have an E-shape, and the first, second, and third coils 21, 23, and 25 are separately wound around the center protrusion 11 formed in a center region of the E-shape of the core 10 so as to form a coil stack structure 20. The first, second, and third coils 21, 23, and 25 are wound to form lines of magnetic force in the same direction when being powered. The lines of magnetic force form ring-shaped magnetic flux loops through the core 10. In this way, the first, second, and third coils 21, 23, and 25 form the same magnetic pole on the horizontal surface of the core 10 to generate electromagnetic force in the same direction.

The first, second, and third coils 21, 23, and 25 are connected in parallel and receives a current. The total inductance of the first, second, and third coils 21, 23, and 25 connected in parallel is smaller than the inductance of a single coil having the same number of turns as the sum of the numbers of turns of the first, second, and third coils 21, 23, and 25. Therefore, the driving device 1 may have relatively fast dynamic characteristics. Because the three coils 21, 23, and 25 are formed by separate coils, the number of turns of each coil may be reduced to lower electricity loss and thus generation of heat, and heat-dissipating areas of the coils may be increased to effectively prevent or reduce thermal deformation of the driving device 1.

In FIGS. 1A and 1B, three coils 21, 23, and 25 are wound around the core 10. However, the inventive concepts are not limited thereto. For example, two, four, or more coils may be wound around the core 10. FIG. 1 illustrates that the first, second, and third coils 21, 23, and 25 have substantially the same number of turns. However, the inventive concepts are not limited thereto. That is, the first, second, and third coils 21, 23, and 25 may have the same number of turns or different numbers of turns.

The driving device 1 controls vertical movement of the object 30 by using an electromagnetic force formed between the magnetic pole of the horizontal surface of the core 10 and the object 30 facing the magnetic pole. In detail, a magnetic material included in the object 30 receives electromagnetic force from the magnetic pole formed on the core 10. Therefore, the object 30 may be supported by the driving device 1 at a position spaced apart from the driving device 1. The distance between the driving device 1 and the object 30 may be adjusted by controlling a current supplied to the three coils 21, 23, and 25 to vary an electromagnetic force formed therebetween.

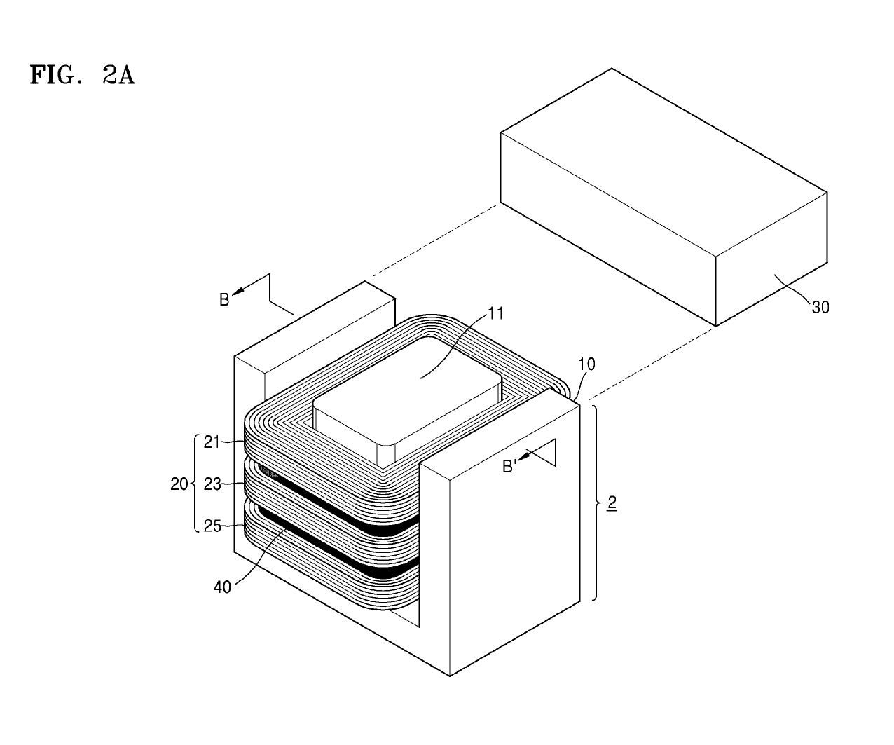

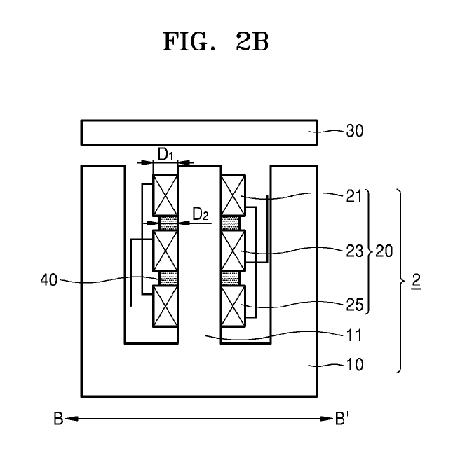

FIG. 2A is a perspective view illustrating a driving device 2 according to example embodiments of the inventive concepts.

Referring to FIG. 2A, a first coil 21, a second coil 23, a third coil 25 are separately wound around a center protrusion 11 of an E-shaped core 10 to form a coil stack structure 20, and first cooling devices 40 are disposed between the first, second, and third coils 21, 23, and 25. The first, second, and third coils 21, 23, and 25 are connected in parallel. An object 30 may be disposed to face a horizontal surface of the core 10 and may be supported by the driving device 2. In FIG. 2A, the object 30 is placed at a position denoted by dashed lines extending from the driving device 2 for clarity.

In example embodiments, the first cooling devices 40 may include a material having high heat-dissipating effects. For example, the first cooling devices 40 may include aluminum.

In example embodiments, the first cooling devices 40 may include cooling fins.

In example embodiments, the first cooling devices 40 may be configured to forcibly perform cooling. For example, the first cooling devices 40 may be water cooling devices, and a water circulation circuit including a water cylinder may be formed. Cooling water may take heat while circulating in the driving device 2 and may lease the heat to the atmosphere while passing through a radiator. Alternatively, the first cooling devices 40 may be air cooling devices configured to take heat from surfaces of the driving device 2 and release heat directly to the atmosphere. In example embodiments, cooling fins may be formed on the driving device 2 to increase the surface area of the driving device 2 and thus to improve heat-dissipating efficiency.

Alternatively, the first cooling devices 40 may be cooling devices using the Peltier effect. For example, the first cooling devices 40 may include a Peltier device or module.

In FIG. 2A, the first cooling devices 40 are disposed between the first, second, and third coils 21, 23, and 25. However, the inventive concepts are not limited thereto. For example, a first cooling device 40 may be disposed in at least one region between the first, second, and third coils 21, 23, and 25.

If a driving device is continuously powered to magnetically levitate an object, considerable electricity may be consumed to operate the driving device, and the wound state of a coil of the driving device may be damaged by ohmic heating. In example embodiments, magnetic force may not be precisely generated. In addition, although the coil is slightly deformed by ohmic heating, the machining precision of a super-precision machine in which the driving device is used may be largely affected. Therefore, in example embodiments of the inventive concepts, the first cooling devices 40 are disposed between the first, second, and third coils 21, 23, and 25 to effectively dissipate heat for reliable operation of the driving device 2.

FIG. 2B is a cross-sectional view illustrating the driving device 2 according to example embodiments of the inventive concepts. Line “B-B” of FIG. 2B denotes that the cross-sectional view of the driving device 2 is taken along line B-B′ of FIG. 2A. In FIGS. 2A and 2B and FIGS. 5A to 6C, the same reference numerals as those used in FIGS. 1A and 1B denote the same elements as those illustrated in FIGS. 1A and 1B, and descriptions thereof will not be repeated.

Referring to FIG. 2B, the first, second, and third coils 21, 23, and 25 are wound around the center protrusion 11 of the E-shaped core 10 with the first cooling devices 40 being disposed therebetween. In this structure, heat generated from the first, second, and third coils 21, 23, and 25 may be effectively dissipated.

In example embodiments, the first cooling devices 40 may be connected to both sides of the first, second, and third coils 21, 23, and 25.

In example embodiments, the first cooling devices 40 may be disposed around the core 10.

In FIG. 2B, the first, second, and third coils 21, 23, and 25 have a diameter-wise length D1 greater than a diameter-wise length D2 of the first cooling devices 40. However, the inventive concepts are not limited thereto. For example, the diameter-wise length D2 of the first cooling devices 40 may be greater than the diameter-wise length D1 of the first, second, and third coils 21, 23, and 25.

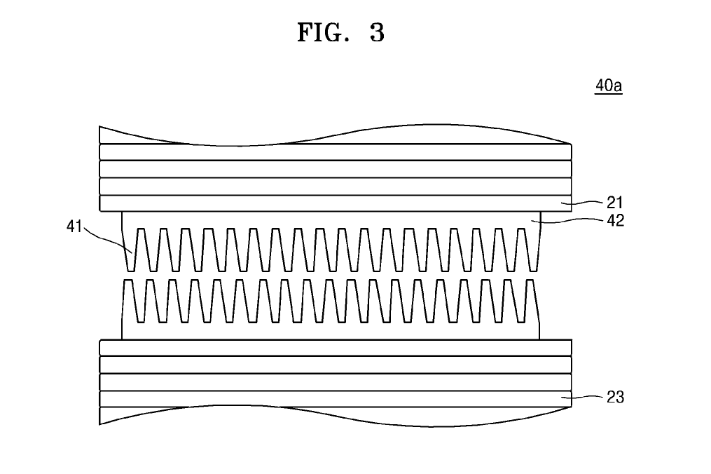

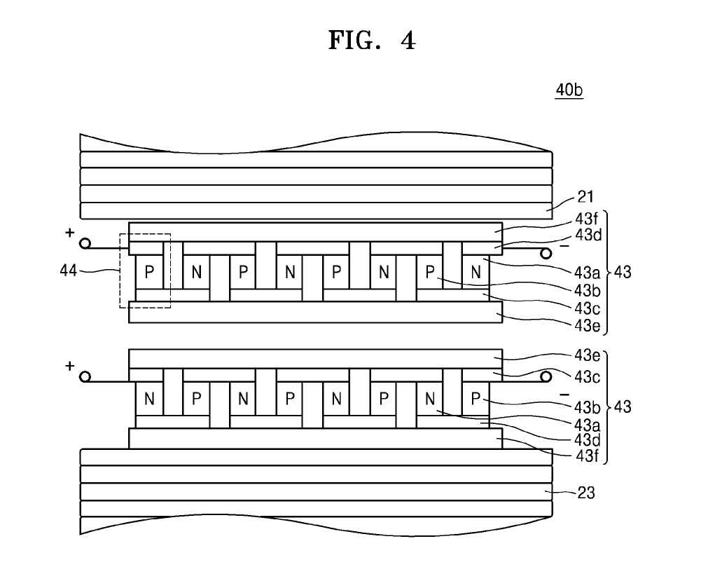

FIGS. 3 and 4 are cross-sectional view illustrating cooling devices 40a and 40b of the driving device 2 according to example embodiments of the inventive concepts.

The cooling device 40a illustrated in FIG. 3 is an example of the first cooling devices 40 illustrated in FIGS. 2A and 2B. The cooling device 40a includes plates 42 on which a plurality of cooling fins 41 are formed. The plates 42 on which the cooling fins 41 are formed are connected to a lower surface of the first coil 21 and a top surface of the second coil 23, respectively. The cooling fins 41 protrude from the plates 42 and are densely arranged on the plates 42 so as to increase the surface areas of the plates 42 and thus to improve cooling efficiency.

The cooling device 40b illustrated in FIG. 4 is an example of the first cooling devices 40 illustrated in FIGS. 2A and 2B. The cooling device 40b includes plates 43 on which a plurality of Peltier modules 43 are formed. Each of n-type semiconductors 43a and p-type semiconductors 43b are connected to first and second electrodes 43c and 43d. The first electrodes 43c are connected to first insulators 43e, and the second electrodes 43d are connected to second insulators 43f. In the Peltier modules 43, the second insulators 43f to which the second electrodes 43d (heat absorbing electrodes) are connected are adjacent to the first and second coils 21 and 23, and the first insulators 43e to which the first electrodes 43c (heat releasing electrodes) are connected are disposed to more easily make contact with air. Holes are formed in portions of the p-type semiconductors 43b close to electrodes having a relatively high electric potential, and the holes move to portions of the p-type semiconductors 43b close to electrodes having a relatively low electric potential. At this time, heat is transferred from the electrodes having a relatively high electric potential to the electrodes having a relatively low electric potential by the movement of the holes. This is based on the basic principle that when an electric charge is transferred between two metals having an electric potential difference, energy necessary for the transfer of the electric charge is taken from the metals.

Referring to a portion indicated by a dashed-line box 44, the second insulator 43f adjacent to the first coil 21 is connected to the second electrode 43d having an electric potential higher than that of the first electrode 43c, and the second electrode 43d is connected to the p-type semiconductor 43b. The p-type semiconductor 43b allow holes to move from the second electrode 43d having a relatively high electric potential to the first electrode 43c having a relatively low electric potential. At this time, heat is absorbed when holes are formed in an interface between the p-type semiconductor 43b and the second electrode 43d having a relatively high electric potential, and the heat is released when the holes disappear in an interface between the p-type semiconductor 43b and the first electrode 43c having a relatively low electric potential.

In example embodiments, the first and second electrodes 43c and 43d may be formed of copper, and the first and second insulators 43e and 43f may be formed of a ceramic material.

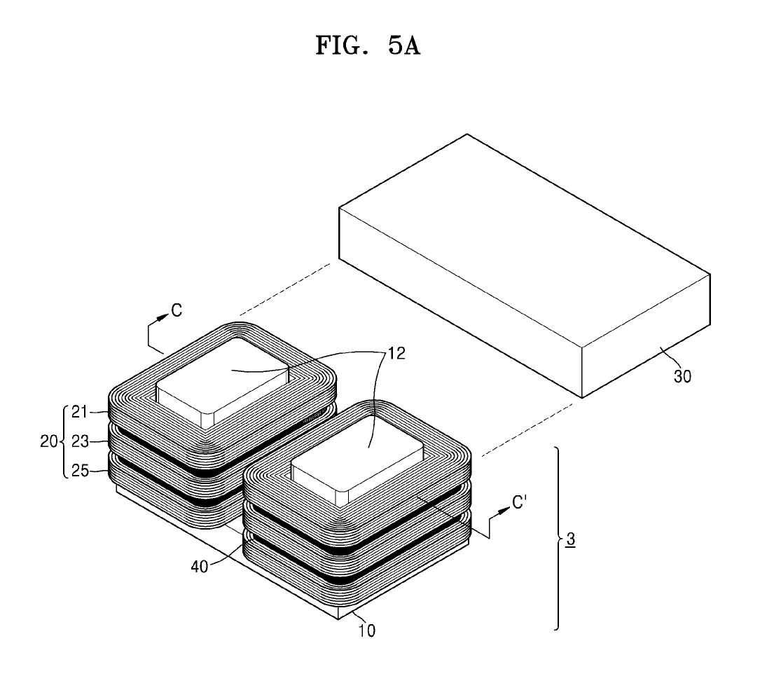

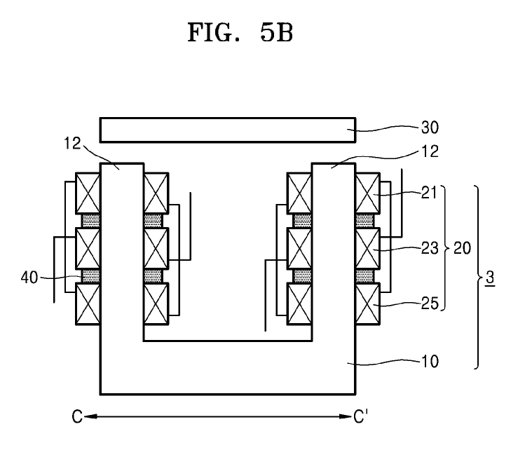

FIGS. 5A and 5B are a perspective view and a cross-sectional view illustrating a driving device 3 according to example embodiments of the inventive concepts. Line “C-C” of FIG. 5B denotes that the cross-sectional view of the driving device 3 is taken along line C-C′ of FIG. 5A.

Referring to FIG. 5A, a first coil 21, a second coil 23, and a third coil 25 are separately wound around each of two protrusions 12 of a C-shaped core 10 to form a coil stack structure 20. The first, second, and third coils 21, 23, and 25 are wound to form lines of magnetic force in the same direction when being powered. The first, second, and third coils 21, 23, and 25 are connected in parallel. First cooling devices 40 are disposed between the first, second, and third coils 21, 23, and 25. In FIG. 5A, the object 30 is placed at a position denoted by dashed lines extending from the driving device 3 for clarity.

Referring to FIG. 5B, the driving device 3 includes the C-shaped core 10 on which the two protrusions 12 are formed, the coil stack structures 20 respectively formed around the two protrusions 12, and the first cooling devices 40 disposed between the first, second, and third coils 21, 23, and 25 of the coil stack structures 20. The first, second, and third coils 21, 23, and 25 are connected in parallel. An object 30 may be disposed to face magnetic poles formed on horizontal surfaces of the two protrusions 12 of the driving device 3, and vertical movement of the object 30 may be controlled by adjusting electromagnetic force of the driving device 3.

In FIGS. 5A and 5B, two coil stack structures 20 are arranged in a direction parallel with a coil winding direction of the core 10. However, the inventive concepts are not limited thereto. For example, three or more coil stack structures 20 may be arranged in a direction parallel with the coil winding direction of the core 10.

Example embodiments may provide a driving device including a core having a plurality of protrusions, and a coil stack structure around at least one of the protrusions.

In example embodiments, at least one connection part may connect the protrusions of the core, and the coil stack structure may be disposed around the connection part. In detail, the core may be C-shaped and may include two protrusions, and the coil stack structure may be disposed around the connection part connecting the two protrusions.

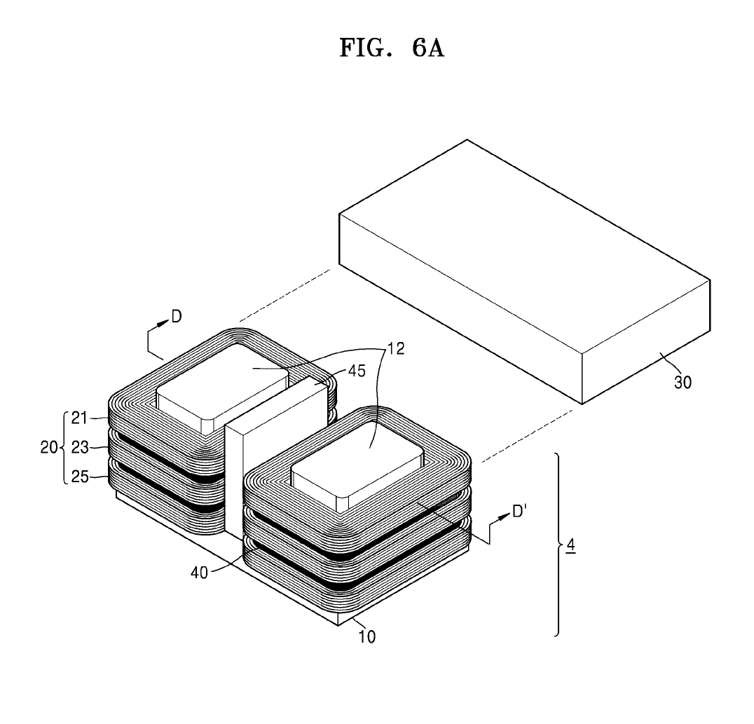

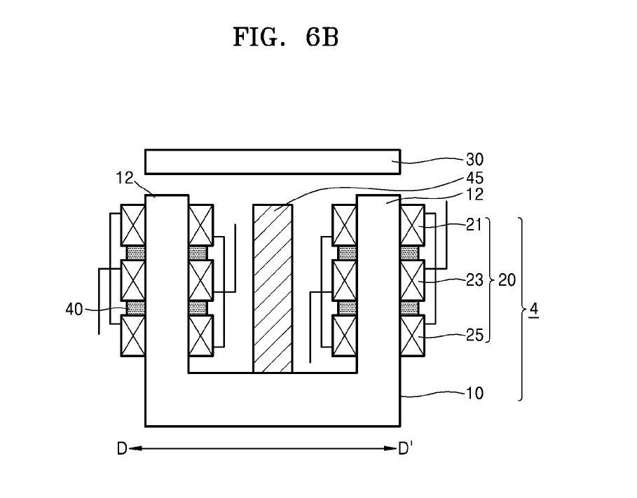

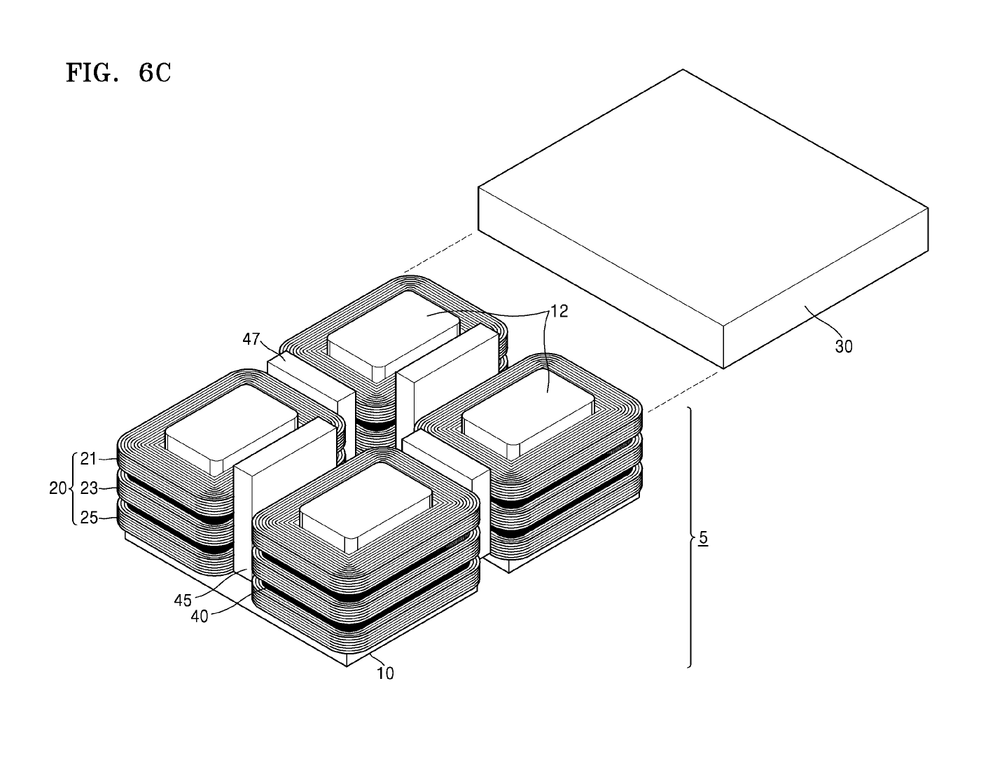

FIGS. 6A and 6B are a perspective view and a cross-sectional view illustrating a driving device 4 according to example embodiments of the inventive concepts.

Referring to FIGS. 6A and 6B, the driving device 4 further includes a second cooling device 45 as compared with the driving device 3 including the core 10, the coil stack structures 20, and the first cooling devices 40. In detail, coil stack structures 20 each including a first coil 21, a second coil 23, and a third coil 25 are disposed respectively around two protrusions 12 of a C-shaped core 10, and at least one second cooling device 45 may be disposed between the coil stack structures 20. In FIG. 6A, the object 30 is placed at a position denoted by dashed lines extending from the driving device 4 for clarity.

In example embodiments, the second cooling device 45 may be formed of a material having a relatively high degree of heat-dissipating effect, e.g., aluminum, and may include cooling fins for increasing the surface area thereof. The second cooling device 45 may be a forced cooling device, e.g., a water forced cooling device, an air forced cooling device, and a Peltier module.

In example embodiments, the type of the second cooling device 45 may be different from that of the first cooling devices 40.

In example embodiments, the second cooling device 45 may be disposed around the coil stack structures 20 to confine the coil stack structures 20 therein.

Referring to FIG. 6C, a driving device 5 is constructed as follows: a plurality of driving devices each including a core 10, coil stack structures 20, first cooling devices 40, and a second cooling device 45 are horizontal arranged and connected to each other, and third cooling devices 47 are disposed between the driving devices 4. An object 30 disposed to face horizontally surfaces of the cores 10 may be driven by electromagnetic force of the driving devices 4. For this, the driving devices 4 are arranged to generate electromagnetic force in the same direction.

FIG. 7A-1 and FIG. 7A-2 are perspective view illustrating a linear motion bearing 6 according to example embodiments of the inventive concepts.

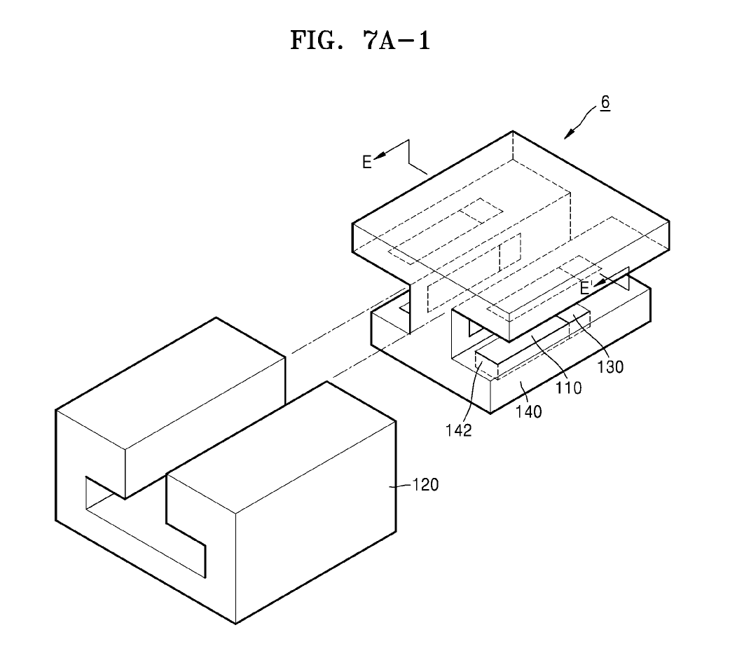

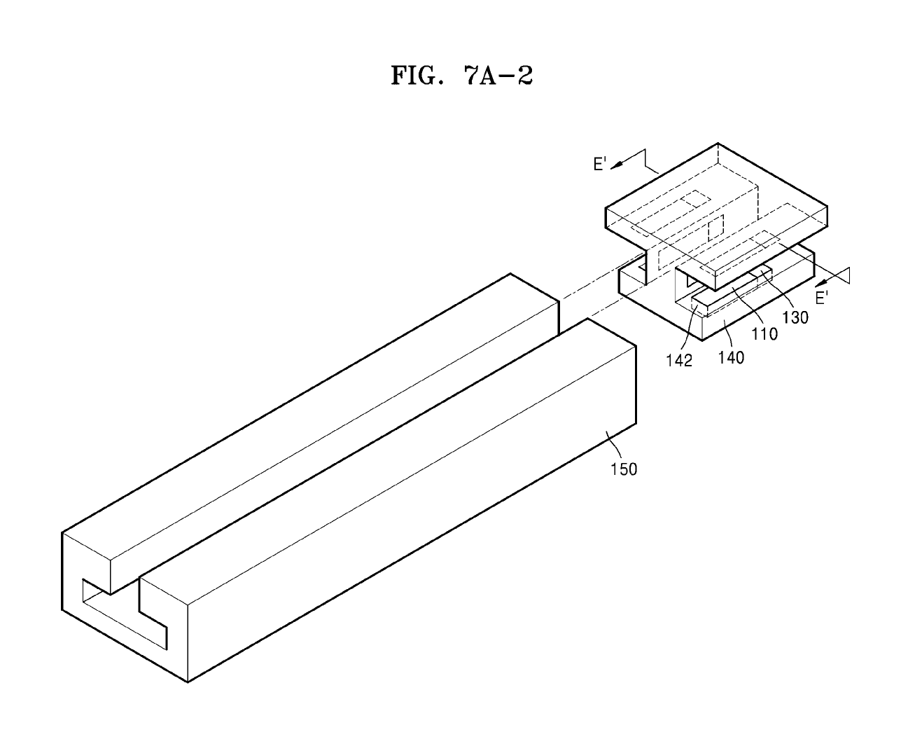

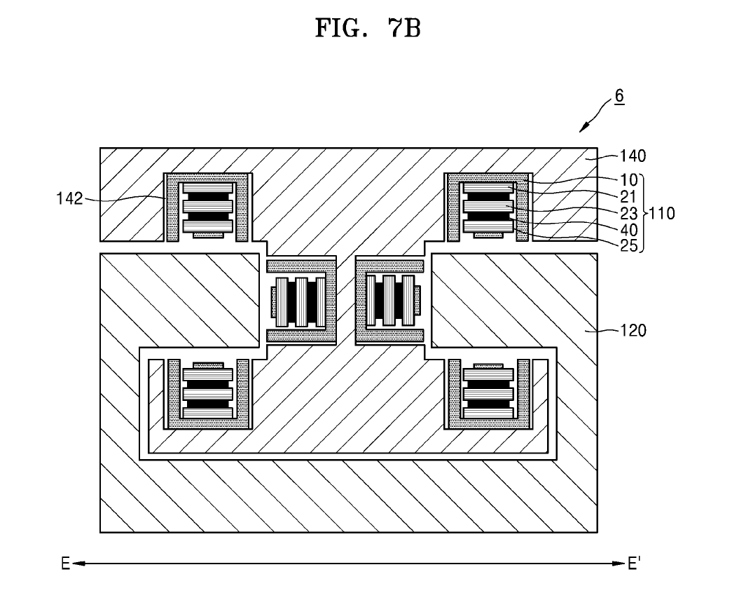

Referring to FIG. 7A-1, the linear motion bearing 6 includes a main body 140 in which electromagnets 110 and controllers 130 are included.

The main body 140 connected to the electromagnets 110 is levitated from an object 120 by electromagnetic forces between the electromagnets 110 and the object 120. The electromagnets 110 are disposed in surfaces of the main body 140 that face the object 120 so as to continuously levitate the main body 140 from the object 120 by electromagnetic force without any contact therebetween. Thus, the electromagnets 110 disposed in the surfaces of the main body 140 may generate forces in vertical and horizontal directions for supporting the main body 140 with respect to the object 120.

In detail, the main body 140 has an H-shape, and the electromagnets 110 are disposed in surfaces of an upper panel, a lower panel, and a connecting part of the H-shaped main body 140. The electromagnets 110 may be disposed in recesses 142 formed in inner walls of the upper panel, the lower panel, and the connecting part. In example embodiments, core surfaces of the electromagnets 110 may be exposed. The electromagnets 110 may have the same structure as that of the driving device 1, 2, 3, 4, or 5 described with reference to FIGS. 1A to 6C.

The object 120 is disposed to face magnetic poles formed on the electromagnets 110. The object 120 may have a shape corresponding to the shape of the main body 140. For example, the object 120 may have a C-shape to surround the main body 140 having an H-shape. The object 120 may have a linear rail shape.

Each of the controllers 130 of the linear motion bearing 6 includes a distance sensor and a current amplifier. The controllers 130 may detect distances between the electromagnets 110 and the object 120 to control currents supplied to the electromagnets 110 and thus to control electromagnetic forces of the electromagnets 110.

Electromagnetic forces of the electromagnets 110 may be balanced in vertical and horizontal directions so as to continuously maintain the main body 140 in a levitated state above the object 120. The controllers 130 collect data about operations of the electromagnets 110, respectively. That is, the controllers 130 are provided for the electromagnets 110, respectively. For example, as shown in FIG. 7B, six pairs of the electromagnets 110 and the controllers 130 may be individually assembled and operated.

Referring to FIG. 7A-2, the main body 140 may be linearly moved along the linear rail 150.

FIG. 7B is a cross-sectional view illustrating the linear motion bearing 6 according to example embodiments of the inventive concepts. Line “E-E” of FIG. 7B denotes that the cross-sectional view of the linear motion bearing 6 is taken along line E-E′ of FIGS. 7A-1 and 7A-2.

Referring to FIG. 7B, each of the electromagnets 110 includes an E-shaped core 10, a coil stack structure 20 including a first coil 21, a second coil 23, a third coil 25 separately wound around a center protrusion of the E-shaped core 10, and first cooling devices 40 disposed between the first, second, and third coils 21, 23, and 25. The first, second, and third coils 21, 23, and 25 are spaced apart from each other. The first, second, and third coils 21, 23, and 25 are wound to form lines of magnetic force in the same direction when being powered. The first, second, and third coils 21, 23, and 25 are connected in parallel. As described above, each of the electromagnets 110 may include a plurality of first cooling devices 40. The electromagnets 110 may have the same structure as that of the driving device 1, 2, 3, 4, or 5 described with reference to FIGS. 1A to 6C.

The electromagnets 110 may be disposed in the recesses 142 formed in the inner walls of the main body 140 having an H-shape, respectively. In example embodiments, the electromagnets 110 are positioned in such a manner that surfaces of the electromagnets 110 in which magnetic poles are formed are exposed to the external environment.

The object 120 is shaped to surround the main body 140 and face the electromagnets 110 inserted into the main body 140. The linear motion bearing 6 having an H-shape and disposed to face the object 120 having a C-shaped cross section may be moved above the object 120 in a levitated state.

FIG. 7B illustrates a state where the linear motion bearing 6 is powered on. In the state, the electromagnets 110 are levitated from the object 120 by electromagnetic force without any contact therebetween.

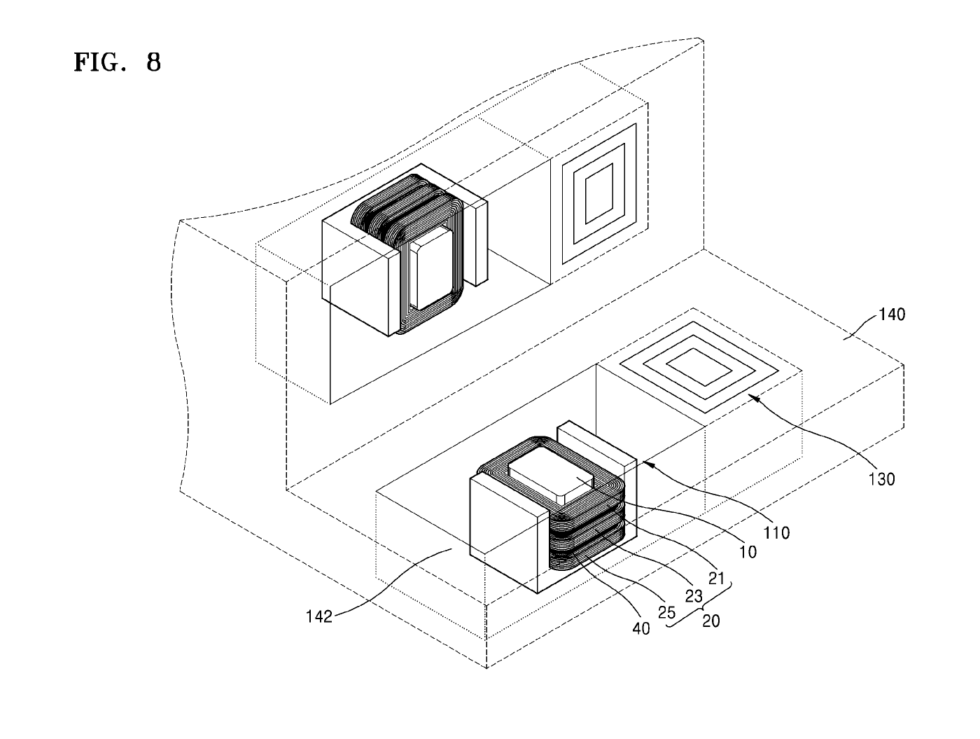

The linear motion bearing 6 illustrated in FIGS. 7A-1 to 7B according to example embodiments of the inventive concepts is shown in FIG. 8 on an enlarged scale. FIG. 8 is an enlarged perspective view illustrating a portion of the linear motion bearing 6.

Referring to FIG. 8, electromagnets 110 and the controllers 130 are inserted into the main body 140. In detail, an electromagnet 110 is disposed in the lower panel of the main body 140 in such a manner that a surface of the core 10 of the electromagnet 110 is exposed to the external environment. In addition, an electromagnet 110 and a controller 130 are inserted into the connection part connecting the upper panel and the lower panel of the main body 140.

FIGS. 9A-1 and 9A-2 are perspective views illustrating a linear motion bearing 7 according to example embodiments of the inventive concepts.

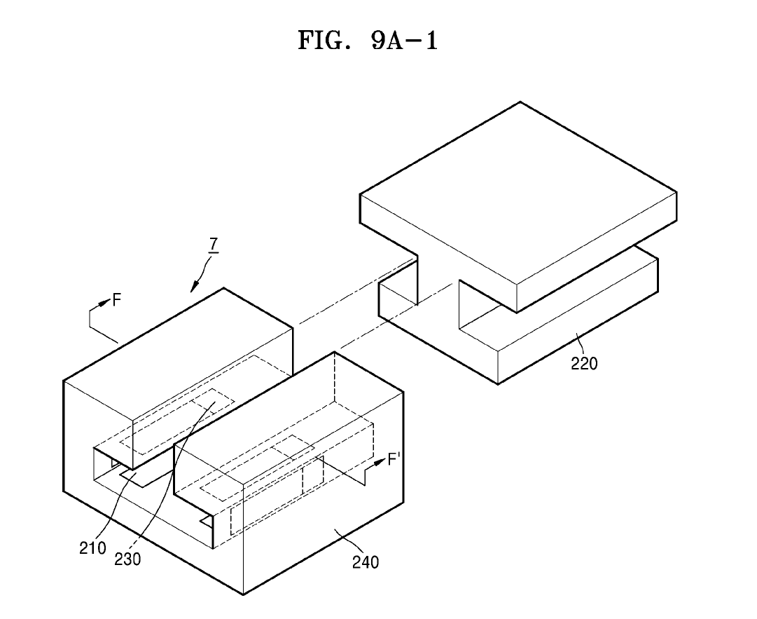

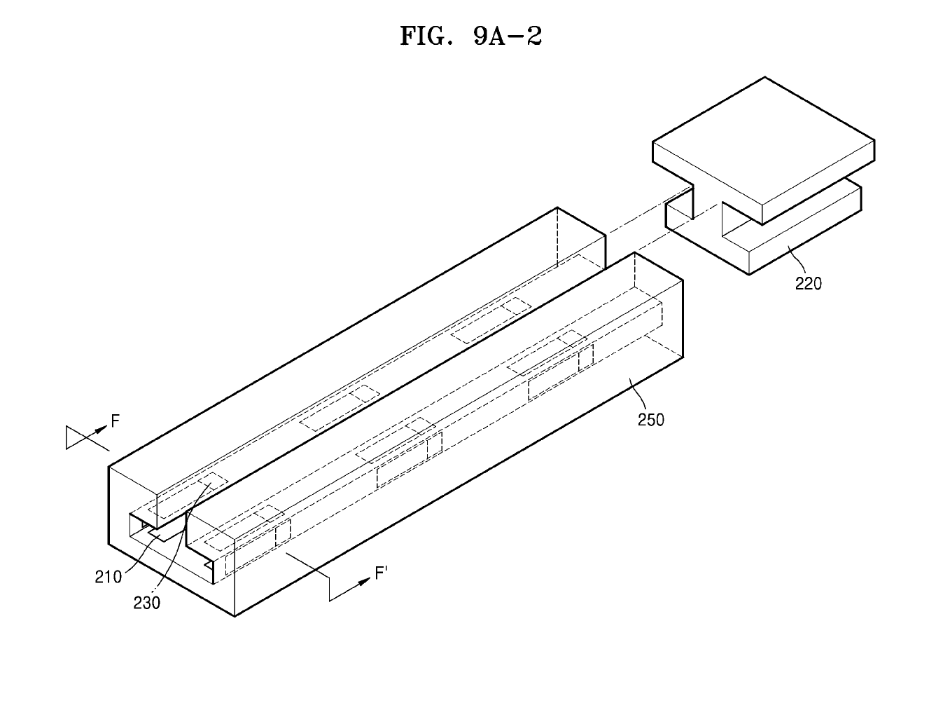

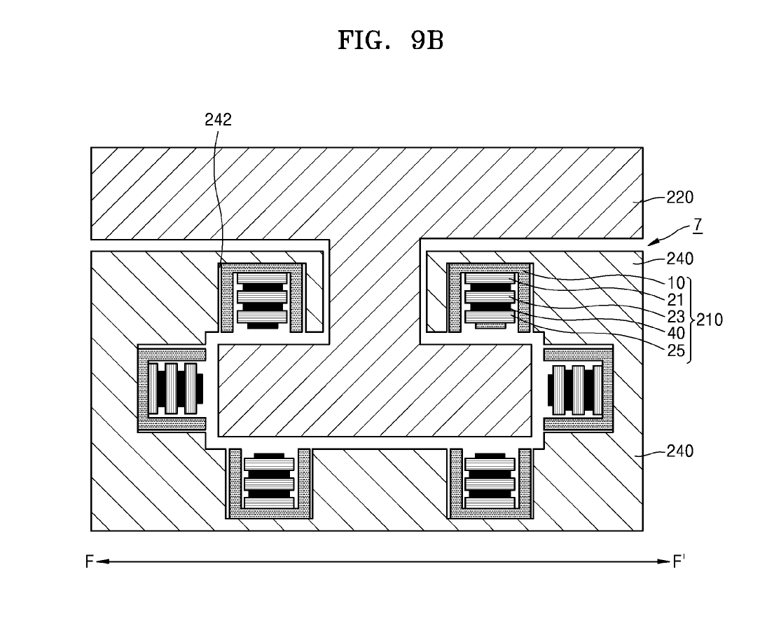

Referring to FIG. 9A-1, electromagnets 210 and controllers 230 are disposed in a main body 240, and the main body 240 has a C-shaped cross section to surround an object 220 having an H-shape. The main body 240 extends in the form of a rail. The electromagnets 210 are disposed in inner walls of the main body 240. In detail, the electromagnets 210 are disposed in surfaces of inner walls of an upper panel, a lower panel, and connection parts connecting both sides of the upper and lower panels so as to levitate the object 220. The electromagnets 210 may be disposed in recesses 242 formed in the inner walls of the upper panel, the lower panel, and the connecting parts connecting both sides of the upper and lower panels. In this structure, core surfaces of the electromagnets 210 may be exposed to the external environment. The electromagnets 210 disposed in the surfaces of the main body 240 may generate supporting forces in vertical and horizontal directions to continuously levitate the object 220 without any contact with the main body 240.

The controllers 230 are provided for the electromagnets 210, respectively. For example, six pairs of the electromagnets 210 and the controllers 230 may be individually assembled and operated so as to balance the object 220 in vertical and horizontal directions without allowing any contact between the object 220 and the main body 240.

In the case of the linear motion bearing 6 illustrated in FIGS. 7A-1 to 8, the main body 140 including the electromagnets 110 is a movable part, and the object 120 is a fixed part. On the other hand, in the case of the linear motion bearing 7 illustrated in FIGS. 9A-1 to 9B, the main body 240 including the electromagnets 210 is a fixed part, and the object 220 facing the main body 240 is a movable part. The object 220 may be linearly moved below the main body 240. The main body 240 may have a linear rail shape.

Referring to FIG. 9A-2, the object 220 may be moved along the linear rail 250.

FIG. 9B is a cross-sectional view illustrating the linear motion bearing 7 according to example embodiments of the inventive concepts. Line “F-F” of FIG. 9B denotes that the cross-sectional view of the linear motion bearing 7 is taken along line F-F′ of FIGS. 9A-1 and 9A-2.

Referring to FIG. 9B, as described with reference to FIGS. 9A-1 and 9A-2, the electromagnets 210 are disposed in the surfaces of the inner walls of the C-shaped main body 240 facing the object 220 in such a manner that surfaces of cores 10 of the electromagnets 210 are exposed to the external environment. The object 220 having an H-shape and facing the linear motion bearing 7 may be moved above the main body 240 having a C-shape in a levitated state. The electromagnets 210 may have the same structure as that of the driving device 1, 2, 3, 4, or 5 described with reference to FIGS. 1A to 6C.

FIG. 9B illustrates a state where the linear motion bearing 7 is powered on. In the state, the object 220 is levitated from the electromagnets 210 by electromagnetic force without any contact therebetween.

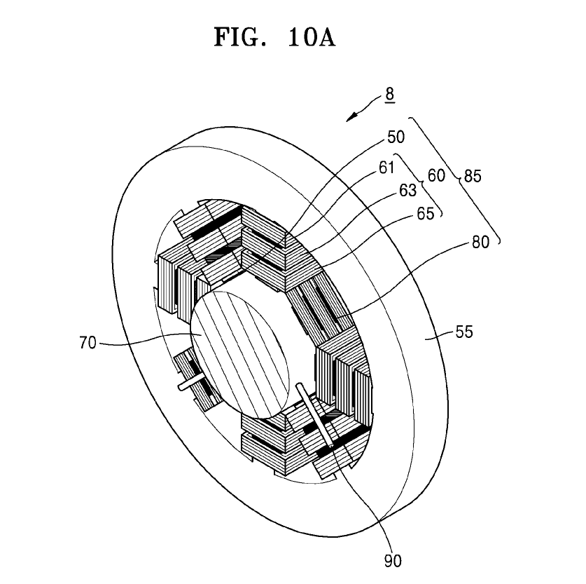

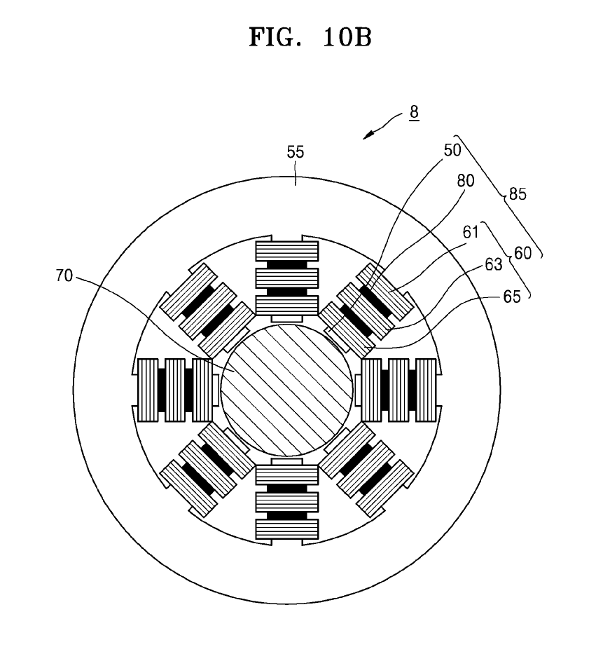

FIG. 10A is a perspective view illustrating a rotary motion bearing 8 according to example embodiments of the inventive concepts.

Referring to FIG. 10A, the rotary motion bearing 8 is disposed around an rotation axis to support a rotation object 70 without making contact with the rotation object 70 when being powered on.

Electromagnets 85 each including a core 50, a coil stack structure 60, and first cooling devices 80 are connected to an inner wall of a ring-shaped part 55 at regular intervals to protrude toward a centerline of the ring-shaped part 55. In detail, a first coil 61, a second coil 63, and a third coil 65 are separately wound around the core 50 to form the coil stack structure 60, and the first cooling devices 80 are disposed between the first, second, and third coils 61, 63, and 65. The first, second, and third coils 61, 63, and 65 are connected in parallel.

In example embodiments, the number of the electromagnets 85 connected to the ring-shaped part 55 may be two or more.

The rotation object 70 is coaxially inserted in the ring-shaped part 55. If the rotary motion bearing 8 is powered on, the rotation object 70 may be supported in a levitated state by electromagnetic force between the rotation object 70 and the electromagnets 85 connected to the ring-shaped part 55.

Controllers 90 may detect distances between the electromagnets 85 and the outer surface of the rotation object 70 disposed at the center of the ring-shaped part 55. The rotation object 70 may be balanced in vertical and horizontal directions so as to be continuously levitated without making contact with the ring-shaped part 55 to which the electromagnets 85 are connected. To this end, current supplied to the electromagnets 85 may be adjusted using the controllers 90 for controlling electromagnetic forces of the electromagnets 85.

In FIG. 10A, each of the electromagnets 85 supporting the rotation object 70 includes the core 50, the coil stack structure 60, and the first cooling devices 80. However, the inventive concepts are not limited thereto. For example, the electromagnets 85 may have the same structure as that of the driving device 1, 2, 3, 4, and 5 described with reference to FIGS. 1A to 6C.

FIG. 10B is a cross-sectional view illustrating the rotary motion bearing 8 according to example embodiments of the inventive concepts.

Referring to FIG. 10B, the electromagnets 85 each including the core 50, the coil stack structure 60, and the first cooling devices 80 are symmetrically arranged on the ring-shaped part 55 at regular intervals.

FIG. 10B illustrates a state where the rotary motion bearing 8 is powered on. In the state, the object 70 is levitated coaxially with the ring-shaped part 55 without making contact with the electromagnets 85 by electromagnetic forces of the electromagnets 85.

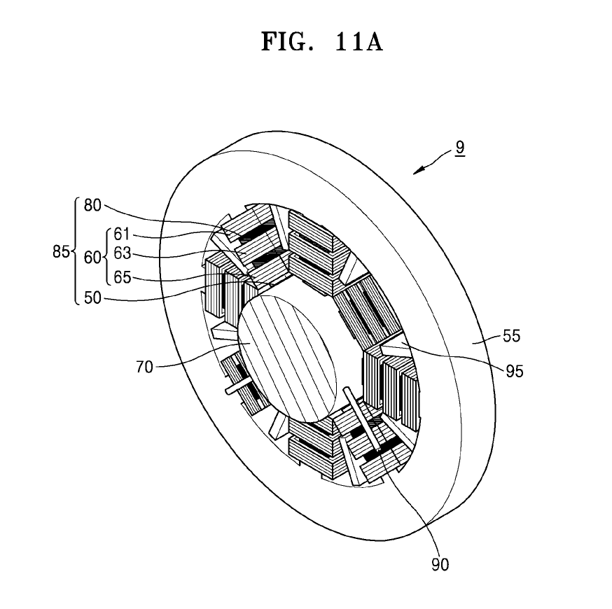

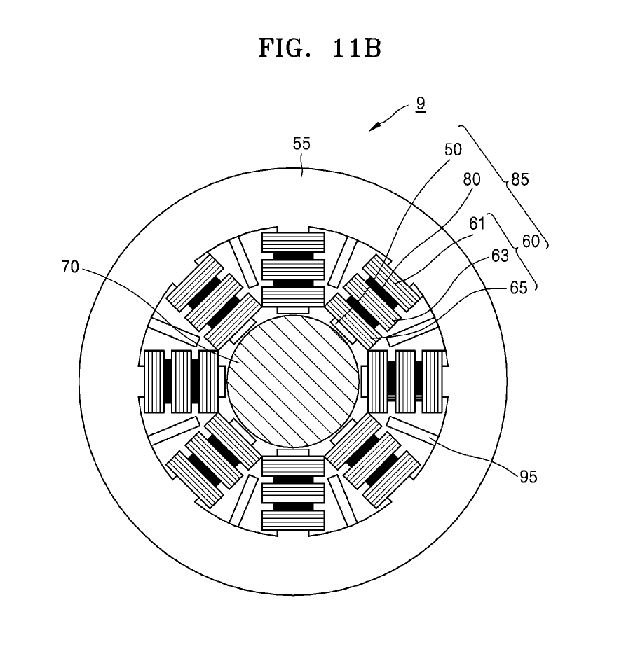

FIGS. 11A and 11B are a perspective view and a cross-sectional view illustrating a rotary motion bearing 9 according to example embodiments of the inventive concepts.

Referring to FIG. 11A, the rotary motion bearing 8 includes a plurality of electromagnets 85 each including a core 50, a coil stack structure 60, and first cooling devices 80, and a ring-shaped part 55 to which the electromagnets 85 are connected. In addition, the rotary motion bearing 8 further includes second cooling devices 95 disposed in gaps between the electromagnets 85. The second cooling devices 95 may be connected to an inner wall of the ring-shaped part 55.

Referring to FIG. 11B, the second cooling devices 95 are disposed in all gaps formed between the electromagnets 85, respectively. However, the inventive concepts are not limited thereto. For example, at least one second cooling device 95 may be disposed between the electromagnets 85.

While the inventive concepts have been particularly shown and described with reference to example embodiments thereof, it will be understood that various changes in form and details may be made therein without departing from the spirit and scope of the following claims.

What is claimed is:

1. A driving device configured to control vertical movement of an object adjacent thereto, the driving device comprising:
a core; and
a plurality of coils connected in parallel and wound around the core to form lines of electromagnetic force in a same direction.

2. The driving device of claim 1, wherein the plurality of coils are arranged in a direction perpendicular to a winding direction thereof to form at least one coil stack structure.

3. The driving device of claim 2, further comprising:
at least one first cooling device between the plurality of coils.

4. The driving device of claim 3, wherein the at least one first cooling device comprises:
a plate adjacent to a side surface of the plurality of coils; and
a plurality of fins on the plate.

5. The driving device of claim 3, wherein
the at least one first cooling device is around the core between the plurality of coils, and
the at least one first cooling device includes a plurality of Peltier modules.

6. The driving device of claim 3, wherein
the at least one first cooling device is a plurality of first cooling devices, and
the plurality of first cooling devices are arranged in a direction perpendicular to the winding direction of the plurality of coils and connected to both sides of the plurality of coils.

7. The driving device of claim 2, wherein a length of each of the plurality of coils measured in a direction perpendicular to the winding direction of the plurality of coils is greater than a gap between an adjacent two of the plurality of coils.

8. The driving device of claim 2, wherein
the core is C-shaped and includes first and second protrusions, and
the at least one coil stack structure includes first and second coil stack structures, the first coil stack structure around the first protrusion and the second coil stack structure around the second protrusion.

9. The driving device of claim 2, wherein
the core includes a plurality of protrusions, and
the at least one coil stack structure is around at least one of the plurality of protrusions.

10. The driving device of claim 2, wherein the at least one coil stack structure includes a plurality of coil stack structures, further comprising:
a second cooling device between an adjacent two of the plurality of coil stack structures.

11. A bearing comprising:
at least one electromagnet including,
a core,
a plurality of coils connected in parallel and wound around the core in a direction perpendicular to a winding direction thereof, and
at least one first cooling device between the plurality of coils; and
a controller configured to detect a distance between the electromagnet and an object facing a magnetic pole of the electromagnet and configured to control a current supplied to the electromagnet according to the distance.

12. The bearing of claim 11, further comprising:
a main body including the at least one electromagnet and the controller, the main body having a surface facing a surface of the object,
wherein the at least one electromagnet is connected to the main body such that a horizontal surface of the at least one electromagnet having the magnetic pole is exposed.

13. The bearing of claim 12, further comprising:
the main body is a rail,
wherein the object is movable along the length of the rail.

14. The bearing of claim 11, further comprising:
a ring-shaped part having an inner wall connected to the at least one electromagnet,
wherein the at least one electromagnet protrudes toward a centerline of the ring-shaped part, and the object is a rotary part having the same centerline as the ring-shaped part.

15. The bearing of claim 14, wherein the at least one electromagnet is a plurality of electromagnets, further comprising:
a second cooling device between the plurality of electromagnets, the second cooling device connected to the inner wall of the ring-shaped part.

16. An electromagnet for a driving device, the electromagnet comprising:
a core; and
at least one coil structure wound around the core, the at least one coil structure including a plurality of coils connected in parallel.

17. The electromagnet of claim 16, wherein the plurality of coils are arranged in a direction perpendicular to a winding direction thereof.

18. The electromagnet of claim 17, further comprising:
at least one first cooling device around the core and between the plurality of coils,
wherein the at least one first cooling device is in a direction perpendicular to the winding direction of the plurality of coils and connected to both sides of the plurality of coils.

19. The electromagnet of claim 18, wherein the at least one coil stack structure includes a plurality of coil stack structures, further comprising:
a second cooling device between an adjacent two of the plurality of coil stack structures.

20. The electromagnet of claim 16, wherein
the core is C-shaped and includes first and second protrusions, and
the at least one coil stack structure includes first and second coil stack structures, the first coil stack structure around the first protrusion and the second coil stack structure around the second protrusion.
